(19) United States
(12) Patent Application Publication
(10) Pub. No.: US 2014/0297392 A1
(43) Pub. Date: Oct. 2, 2014

(54) ELECTRONIC COUPON DISTRIBUTION AND REDEMPTION

(71) Applicant: William B. Moffitt, Gainesville, GA (US)

(72) Inventor: William B. Moffitt, Gainesville, GA (US)

(21) Appl. No.: 14/224,614

(22) Filed: Mar. 25, 2014

Related U.S. Application Data
(60) Provisional application No. 61/805,377, filed on Mar. 26, 2013.

(51) Int. Cl. G06Q 30/02

(52) U.S. Cl. CPC G06Q 30/0238
USPC 705/14.38

(57) ABSTRACT

A system includes a processor that generates a coupon savings account for a consumer. The coupon savings account includes coupon preference data received from a consumer device of the consumer The processor associates a consumer identifier with the coupon savings account. The processor receives digital coupon data from an issuer-device. The digital coupon data includes a discount for the product or service. The processor associates the digital coupon data with the coupon savings account based at least in part on the coupon preference data The processor receives purchase data from a retailer device. The purchase data includes the consumer identifier and an indication that the consumer is purchasing the product or service The processor causes the digital coupon data to be sent to the retailer device. The processor generates an invoice. The invoice indicates an amount of funds to be transferred from an issuer financial account.

### CROSS-REFERENCE TO RELATED APPLICATIONS

The present application claims priority to U.S. Provisional Application No. 61/805,377 filed on Mar. 26, 2013, the entire disclosure of which is incorporated herein by reference.

### BACKGROUND

Retail establishments are an important party of daily life. Often, persons visit retail establishments to purchase many of the items they need to live each day. For example, clothing, foodstuffs, pharmaceuticals, toiletries, home goods, and hardware are all things that may be purchased at retail stores. Retail stores may sell some or all of these types of items.

A manufacturer of goods and the retailer of such goods both have an interest in the retailer selling the goods to customers. As a result, retailers and manufacturers, jointly or separately, may offer sales or promotions in order to increase sales and/or profitability of the goods and products being offered for sale. A sale may come in the form of a coupon offered to customers. When a customer uses a coupon, the customer receives some sort of benefit when purchasing a good or product being offered for sale. For example, a coupon may entitle a customer to $1.00 off of a product, or a coupon may entitle a customer to get 3 units of a product for the normal price of 2 units of the product.

### SUMMARY

A system includes a memory and a processor coupled to the memory. The processor generates a coupon savings account for a consumer. The coupon savings account includes coupon preference data received from a consumer device of the consumer The coupon preference data also indicates a preference of the consumer for a particular type of product or service. The processor also associates a consumer identifier with the coupon savings account. The processor also receives digital coupon data from an issuer-device. The digital coupon data includes a discount for the product or service. The processor also associates the digital coupon data with the coupon savings account based at least in part on the coupon preference data The processor also receives purchase data from a retailer device. The purchase data includes the consumer identifier and an indication that the consumer is purchasing the product or service The processor also causes the digital coupon data to be sent to the retailer device. The processor also receives purchase confirmation data from the retailer device. The purchase confirmation data indicates that the discount for the product or service was applied. The processor also generates an invoice. The invoice indicates an amount of funds to be transferred from an issuer financial account. The amount of funds is based on the amount of the discount for the product or service. The processor also causes the invoice to be sent to the issuer device.

A method includes generating, by a processor of a computing device, a coupon savings account for a consumer. The coupon savings account includes coupon preference data received from a consumer device of the consumer. The coupon preference data also indicates a preference of the consumer for a particular type of product or service. The method also includes associating, by the processor of the computing device, a consumer identifier with the coupon savings account. The method also includes receiving, by the processor of the computing device, digital coupon data from an issuer-device. The digital coupon data includes a discount for the product or service. The method also includes associating, by the processor of the computing device, the digital coupon data with the coupon savings account based at least in part on the coupon preference data. The method also includes receiving, by the processor of the computing device, purchase data from a retailer device. The purchase data includes the consumer identifier and an indication that the consumer is purchasing the product or service. The method also includes causing, by the processor of the computing device, the digital coupon data to be sent to the retailer device. The method also includes receiving, by the processor of the computing device, purchase confirmation data from the retailer device. The purchase confirmation data indicates that the discount for the product or service was applied. The method also includes generating, by the processor of the computing device, an invoice. The invoice indicates an amount of funds to be transferred from an issuer financial account. The amount of funds is based on the amount of the discount for the product or service. The method also includes causing, by the processor of the computing device, the invoice to be sent to the issuer device.

A non-transitory computer readable medium having instructions stored thereon for execution by a processor. The computer readable medium includes instructions to generate, by the processor, a coupon savings account for a consumer. The coupon savings account includes coupon preference data received from a consumer device of the consumer. The coupon preference data also indicates a preference of the consumer for a particular type of product or service. The computer readable medium also includes instructions to associate, by the processor, a consumer identifier with the coupon savings account. The computer readable medium also includes instructions to receive, by the processor, a digital coupon data from an issuer-device. The digital coupon data comprises a discount for the product or service. The computer readable medium also includes instructions to associate, by the processor, the digital coupon data with the coupon savings account based at least in part on the coupon preference data. The computer readable medium also includes instructions to receive, by the processor, purchase data from a retailer device. The purchase data includes the consumer identifier and an indication that the consumer is purchasing the product or service. The computer readable medium also includes instructions to cause, by the processor, the digital coupon data to be sent to the retailer device. The computer readable medium also includes instructions to receive, by the processor, purchase confirmation data from the retailer device. The purchase confirmation data indicates that the discount for the product or service was applied. The computer readable medium also includes instructions to generate, by the processor, an invoice. The invoice indicates an amount of funds to be transferred from an issuer financial account. The amount of funds is based on the amount of the discount for the product or service. The computer readable medium also includes instructions to cause, by the processor, the invoice to be sent to the issuer device.

### BRIEF DESCRIPTION OF THE DRAWINGS

Illustrative embodiments will hereafter be described with reference to the accompanying drawings.

FIG. 1 is a block diagram illustrating computing devices, a client-device, a server, an issuer-device, and a retailer-device, that may be used in accordance with an illustrative embodiment.

FIG. 2 is a block diagram illustrating a server memory and memory blocks that may exist in the server memory in accordance with an illustrative embodiment.

FIG. 3 is a flow diagram illustrating a method of establishing a consumer profile and consumer Coupon Savings Account (CSA) in accordance with an illustrative embodiment.

FIG. 4 is a flow diagram illustrating a method of providing consumer profile information to a coupon issuing-device in accordance with an illustrative embodiment.

FIG. 5 is a flow diagram illustrating a method of acquiring consumer profile information from a server and issuing coupons in accordance with an illustrative embodiment.

FIG. 6 is a flow diagram illustrating a method for discounting a purchase based on digital coupons in accordance with an illustrative embodiment.

FIG. 7 is a flow diagram illustrating a second method for discounting a purchase based on digital coupons in accordance with an illustrative embodiment.

FIG. 8 is a flow diagram illustrating a method for issuing payments from a coupon issuer to a retailer based on purchases using coupons in accordance with an illustrative embodiment.

FIG. 9 is a flow diagram illustrating a method for updating a coupon distribution campaign and consumer Coupon Savings Account (CSA) based on purchases using coupons in accordance with an illustrative embodiment.

FIG. 10 is a process flow diagram demonstrating a coupon distribution method in accordance with an illustrative embodiment.

FIG. 11 is a process flow diagram demonstrating a coupon redemption method in accordance with an illustrative embodiment.

FIG. 12 is a process flow diagram demonstrating an invoice generation associated with a coupon reimbursement method in accordance with an illustrative embodiment.

FIG. 13 is a process flow diagram demonstrating a financial transaction associated with a coupon reimbursement method in accordance with an illustrative embodiment.

### DETAILED DESCRIPTION

Described herein are illustrative embodiments for methods and systems that provide for digitally targeted distribution, electronic redemption, and electronic reimbursement of coupons. A consumer may establish a consumer Coupon Savings Account (CSA). The CSA may contain information such as profile and demographic information of a consumer, as well as prior purchase history of the consumer. A coupon issuer such as a manufacturer of products may access the consumer profile, demographic information, and prior purchase history to target the distribution of coupons to certain individuals or classes of individuals. The coupon issuer may then issue coupons that are assigned to a consumer's CSA. When a consumer goes to a retailer to make purchases, the consumer may present or enter an identification number that is associated with the consumer CSA. Upon making a purchase at the retailer, the system will receive the identification number, and identify coupons that have been assigned to a consumer's CSA. The system can then apply the coupons in order to discount the cost of the purchase in accordance with the coupons in the CSA. This discount may be done automatically, without the consumer necessarily even having prior knowledge that the applied coupon was assigned to their CSA. Additionally, a discount may be given to a consumer without the consumer having to take action regarding the individual coupon. The system may track coupons used and deductions given to a consumer. Using this information, the system may initiate a payment from the issuer of a coupon to the retailer that redeemed the coupon, in order to reimburse the retailer for the discount given to the consumer on behalf of the coupon issuer. This payment may be administrated and executed electronically.

The CSA may act like an account of coupons for consumers wherein retailers and manufacturers deposit coupons on behalf of the consumer thereby relieving the consumer of the task of locating coupons for products they have demonstrated a desire to receive through a consumer profile and prior purchase history. Redemption of all applicable coupons may be accomplished electronically via an application programming interface (API) when a consumer's unique customer identification number is keyed or scanned into a retailer's point-of-sale (POS) system, which in turn communicates with a computer server containing consumer profiles, purchase history, CSAs, and an electronic invoicing system.

Paper coupons, discounts, and offers (collectively referred to herein as “coupons”) have historically been delivered to consumers by product manufacturers. Often a coupon may be delivered to a potential consumer using free-standing inserts, often located inside newspapers, magazines and other physical media types. The physical production and distribution of coupons delivered as free-standing inserts may not offer the manufacturer or issuer of the coupon control of who receives and/or redeems a coupon. In addition, there may be no method for controlling how many coupons are actually redeemed with the free-standing insert method. For example, a manufacturer may want to limit exposure of how many coupons in a distribution can actually be redeemed, but may not be able to so limit redemption if using free-standing inserts. Additionally, a retailer may also want to limit the number of coupons that can be redeemed at a store, for example limiting the number of redeemable coupons to a number of in stock products or available services for which the coupon applies. Additionally, the use of free-standing insert coupons may include browsing an insert by a consumer, identifying a coupon as pertaining to a product of interest, physically cutting out the coupon with scissors, and presenting the coupon to a retailer, which may then be physically scanned into the retailer's point-of-sale (POS) system. Many free-standing insert coupons are single-use and once redeemed, may not be used again. Upon acceptance of a coupon by the retailer, a consumer receives the discount as advertised on the coupon. The retailer may then submit the paper copy of the coupon to the issuer of the coupon in accordance with the issuer's redemption policy for reimbursement of the face value of the coupon. A redemption process may also involve the retailer, or its agent, shipping the paper coupon to an issuer approved third-party clearing house where the paper coupon is placed on a conveyor belt and scanned. An invoice may be generated by the third-party clearing house to the issuer of the coupon for the face value of the coupon, plus a handling fee. When an issuer makes a payment to the clearing house, the clearing house may then send a check for the face value of the coupon back to the original retailer that redeemed the coupon from the consumer. The total time to reimburse the retailer for redeeming the coupon may be 30-60 days from the time the coupon is accepted by the retailer.

Digital versions of free-standing coupons may also be made available to consumers online via the internet. A consumer may go to any number of coupon web sites, locate coupons of interest, print them individually, and then go to any retailer that accepts coupons for redemption. Internet printed coupons may be treated just as if they were paper coupons clipped from a newspaper, magazine or other physical media type. Such coupons may also be single-use, and also may still be submitted by a retailer to an issuer's approved third-party clearing house in accordance with the issuer's advertised redemption policy for reimbursement of the face value of the coupon. As with paper free-standing insert coupons, there may be no controls for who redeems the coupon, nor a method for controlling how many of the coupons are actually redeemed as they can be freely printed from the internet by any consumer with access to the internet and a printer.

Consumers may also browse through numerous internet web sites to locate coupons of interest and then digitally link coupons to a registered, store-specific loyalty card. A consumer may go to the specific store that issued the loyalty card to redeem the coupons that were digitally linked to the card. The retailer may be required to submit evidence of the transaction involving the coupon to the issuer in accordance with the issuer's advertised redemption policy for reimbursement of the face value of the coupon, a process that may take approximately fifteen (15) days. Similar to printed free-standing insert coupons in newspapers, magazines, and the like, digital versions of free-standing inserts may not be delivered automatically to a consumer, but may instead be sought out by a consumer. Furthermore, a digital version of a free-standing insert may involve a consumer taking action to locate, print, and redeem the coupon.

The present disclosure is directed to a method, system, and computer-readable medium for digitally targeted distribution of coupons to a consumer's Coupon Savings Account (CSA), and electronic redemption and reimbursement of the coupons. The digitally targeted distribution may be based upon a consumer's personal profile and/or prior purchase history. Advantages of the method and system may include, without limitation, the digitally targeted CSA approach to coupon distribution and redemption. In an illustrative embodiment, coupon issuers may have a single distribution outlet in which to digitally target coupons directly to consumers that are most likely to redeem them. Issuers may determine customers most likely to redeem coupons based on a consumer's profile and/or prior purchase history. Another advantage of the disclosed system and method is that it may also eliminate or reduce costs associated with printing and distributing paper coupons, and even further may eliminate the need for third-party clearing houses to process paper coupons. Consumers may also enjoy the benefits of receiving coupons that they have indicated a desire to receive through their profile and/or purchase history. A further advantage is that consumers may redeem coupons at any participating retailer instead of at a particular retailer, without efforts of the consumer such as locating a coupon, cutting it out, printing if off, carrying it to the store, or even knowing of the coupon's existence. Such a system and method may be implemented through an Application Programming Interface (API) integrated into a retailer's point of sale (POS) system. In the API, all of a consumer's coupons may be redeemed simultaneously by providing a unique Consumer Identifier (CI) at checkout, rather than producing and/or redeeming individual coupons. Additional advantages of the present system include: (1) Coupons may be digitally delivered directly to a consumer's account. (2) Coupons may have guaranteed delivery to reach a consumer being targeted. (3) An issuer of a coupon may maintain control over financial exposure by setting limits on coupon redemptions. (4) Detailed consumer demographic data may be available to issuers of coupons for every redemption of a coupon. (5) Coupons may be distributed without a third party coupon distributor. (6) Coupons may be redeemed without the use of a store-specific loyalty card. (7) A consumer may determine which types of coupons he/she would like to receive. (8) Retailers may receive a reimbursement for the face value of a redeemed coupon in 3-5 days or less from redemption.

Illustrative embodiments allow for a consumer to use a web based application to view coupons that have been issued to the consumer. If a consumer then goes shopping at a participating retailer and the consumer provides their consumer identifier (CI), the coupons and discounts will be automatically applied to the prices the consumer pays for the goods or services. Thus, a consumer may target their shopping based on the advertisements they have seen in their coupon savings account (CSA). In an alternative embodiment, a consumer may not have knowledge of a particular coupon that is in his/her CSA. However, if the coupon has been assigned to the consumer's CSA, it may be redeemed upon purchase of the relevant good or service regardless of whether the consumer had knowledge of the coupon. This may serve to entice consumers to shop at participating retailers more often, with the consumer hoping they may be fortunate enough to get a discount on products or services purchased.

Another feature of the disclosed embodiments is added security features. For example, linking individual coupons to a specific consumer's CSA may prevent a consumer from using coupons fraudulently, or using more coupons than is allowed under the parameters of a coupon distribution campaign. In other words, the disclosed embodiments may include consumer-specific account level access, such as a password or other access restricting features. For example, an embodiment may associate a particular IP (internet protocol) address with a CSA. If an address of a consumer's CSA is known, access to the account may require the use of a computing device with the known IP address. If a different device is used, further security protocols may be followed such as using security questions. A security question may prompt a consumer to enter personal information that only the consumer would know. The security questions may be set up by the consumer when a CSA is created. In another embodiment, the security questions may be related to information inputted by a consumer when the consumer sets up his/her CSA. A deposited coupon in a consumer's CSA may be redeemable when a consumer provides a CI, and thus a coupon can only be redeemed as many times as a coupon issuer allows the particular CSA to redeem the coupon. Additionally, with some illustrative embodiments, there may be no digital or print production of a coupon code which could be redeemed by a consumer outside of the disclosed embodiments. Thus, the system may prevent fraudulent reproductions of coupons or coupon codes.

One illustrative embodiment, disclosed herein only by way of example, is applying the electronic coupon distribution and redemption system to a retail supermarket, pharmacy, service provider, retail store, etc. environment where targeted distribution of consumer packaged goods (CPG) coupons are directly added to a consumer's account, where there is integration of the system into the retailer's POS system, and where bulk redemption of multiple CPG coupons in a single transaction with a single account number may be accomplished. A retailer or retail store is used herein and throughout to refer to any merchant or commercial establishment where consumers can pay for goods or services.

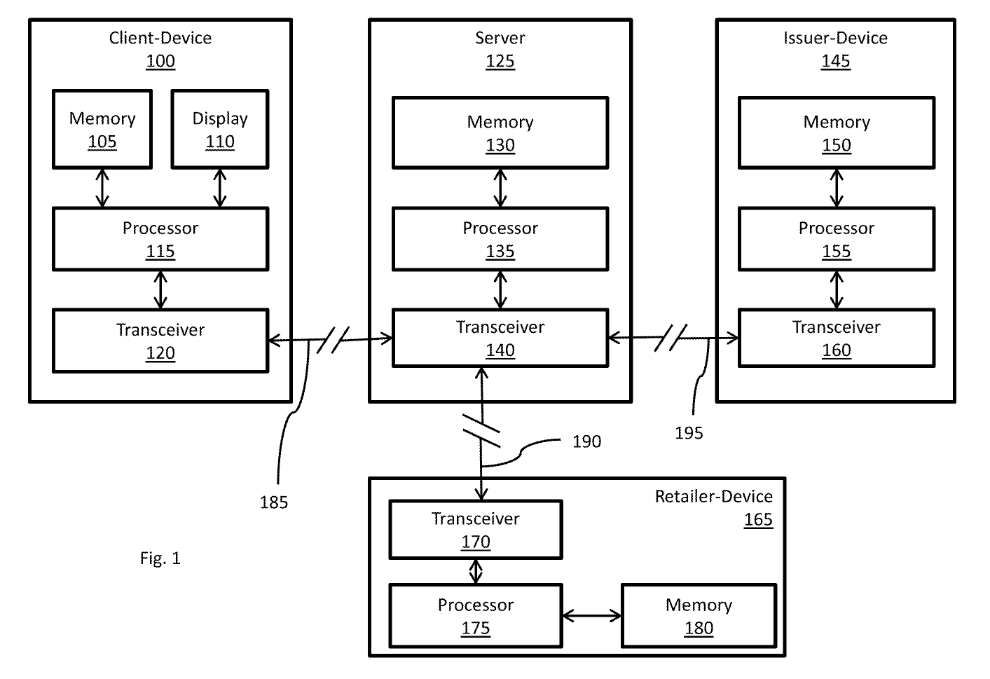

FIG. 1 is a block diagram illustrating computing devices, a client-device, a server, an issuer-device, and a retailer-device, that may be used in accordance with an illustrative embodiment. In alternative embodiments, fewer, additional, and/or different components may be included in the system. In FIG. 1, there is a client-device 100, a server 125, an issuer-device 145, and a retailer-device 165. The client-device includes a processor 115 that is coupled to a memory 105. The processor 115 can store and recall data and applications in the memory 105. The processor 115 may also display objects, applications, data, etc. on the display 110. The processor 115 is also coupled to a transceiver 120. With this configuration, the processor 115, and subsequently the client-device 100, can communicate with other devices, such as the server 125 through a connection 185.

The server 125 includes a processor 135 that is coupled to a memory 130. The processor 135 can store and recall data and applications in the memory 130. The processor 135 is also coupled to a transceiver 140. With this configuration, the processor 135, and subsequently the server 125, can communicate with other devices, such as the client-device 100 through a connection 185.

The issuer-device 145 includes a processor 155 that is coupled to a memory 150. The processor 155 can store and recall data and applications in the memory 150. The processor 155 is also coupled to a transceiver 160. With this configuration, the processor 155, and subsequently the issuer-device 145, can communicate with other devices, such as the server 125 through a connection 195.

The retailer-device 165 includes a processor 175 that is coupled to a memory 180. The processor 175 can store and recall data and applications in the memory 180. The processor 175 is also coupled to a transceiver 170. With this configuration, the processor 175, and subsequently the retailer-device 165, can communicate with other devices, such as the server 125 through a connection 190.

The devices shown in the illustrative embodiment may be utilized in various ways. For example, any of the connections 185, 190, and 195 may be varied. Any of the connections 185, 190, and 195 may be a hard wired connection. A hard wired connection may involve connecting the devices through a USB (universal serial bus) port, serial port, parallel port, or other type of wired connection that can facilitate the transfer of data and information between a processor of a device and a second processor of a second device, such as between the server 125 and the retailer-device 165. In another embodiment, any of the connections 185, 190, and 195 may be a dock where one device may plug into another device. While plugged into a dock, the client-device may also have its batteries charged or otherwise be serviced. In other embodiments, any of the connections 185, 190, and 195 may be a wireless connection. These connections may take the form of any sort of wireless connection, including but not limited to Bluetooth connectivity, Wi-Fi connectivity, or another wireless protocol. Other possible modes of wireless communication may include near-field communications, such as passive radio-frequency identification (RFID) and active (RFID) technologies. RFID and similar near-field communications may allow the various devices to communicate in short range when they are placed proximate to one another. In an embodiment using near field communication, two devices may have to physically (or very nearly) come into contact, and one or both of the devices may sense various data such as acceleration, position, orientation, velocity, change in velocity, IP address, and other sensor data. The system can then use the various sensor data to confirm a transmission of data over the internet between the two devices. In yet another embodiment, the devices may connect through an internet (or other network) connection. That is, any of the connections 185, 190, and 195 may represent several different computing devices and network components that allow the various devices to communicate through the internet, either through a hard-wired or wireless connection. Any of the connections 185, 190, and 195 may also be a combination of several modes of connection.

To operate different embodiments of the system or programs disclosed herein, the various devices may communicate in different ways. For example, the client-device 100, issuer-device 145, and retailer-device 165 may download various software applications from the server 125 through the internet. Such software applications may allow the various devices in FIG. 1 to perform some or all of the processes and functions described herein. Additionally, the embodiments disclosed herein are not limited to being performed only on the disclosed devices in FIG. 1. It will be appreciated that many various combinations of computing devices may execute the methods and systems disclosed herein. Examples of such computing devices may include automated cash registers, smart phones, personal computers, servers, laptop computers, tablets, blackberries, RFID enabled devices, or any combinations of such devices.

In one embodiment, a download of a program to the client-device 100 involves the processor 115 receiving data through the transceiver 120 from the transceiver 140 of the server 125. The processor 115 may store the data (like the program) in the memory 105. The processor 115 can execute the program at any time. In other embodiments, the issuer-device 145 and the retailer-device 165 may download programs in a similar manner to the client-device. In another embodiment, some aspects of a program may not be downloaded to the client-device 100, issuer-device 145, and retailer-device 165. For example, the program may be an application that accesses additional data or resources located in the server 125. In another example, the program may be an internet-based application, where the program is executed by a web browser and stored almost exclusively in the server 125. In the latter example, only temporary files and/or a web browser may be used on the client-device 100 in order to execute the program, system, application, etc.

In yet another embodiment, once downloaded to the client-device 100, the program may operate in whole or in part without communication with the server 125. In this embodiment, the client-device 100 may access or communicate with the server 125 only when acquiring the program, system, application, etc. through the connection 185. In other embodiments, a constant or intermittent connection 185 may exist between the server 125 and the client-device 100. Where an intermittent connection exists, the client-device 100 may only need to communicate data to or receive data from the server 125 occasionally.

The configuration of the server 125, the client-device 100, the issuer-device 145, and the retailer-device 165 is merely one physical system on which the disclosed embodiments may be executed. Other configurations of the devices shown may exist to practice the disclosed embodiments. Further, configurations of additional or fewer devices than the ones shown in FIG. 1 may exist to practice the disclosed embodiments. Additionally, the devices shown in FIG. 1 may be combined to allow for fewer devices or separated where more than the four devices shown exist in a system.

In some embodiments, the devices shown in FIG. 1 may be existing devices that are owned or possessed by a respective client, issuer, or retailer using the embodiments disclosed herein. In such an embodiment, the client, issuer, or retailer may only need to download software (e.g., an application or ‘app’) to the existing device to execute the various embodiments disclosed herein. In other embodiments, specialized hardware may be used by the client, issuer, or retailer, that is specifically designed to perform or execute the various embodiments disclosed herein. For example, if an RFID chip is used to retrieve a consumer's consumer identifier (CI), a cash register installed at a supermarket may not have the hardware to be equipped to read an RFID and acquire the CI. As such, hardware may be specifically designed to provide such capabilities. Some embodiments of this may include a specifically designed computing device, or it may include a hardware plug-in to a computing device. For the latter example, a RFID reader that can plug into a computing device such as a cash register, credit card scanner, etc. may be used.

In one embodiment, the consumer identifier may include a combination of information associated with a given consumer. For example, during registration and/or a first time use at a retailer location, a consumer can select (or be assigned) a pin number or other code that is specific to the consumer. As just one example, a four digit pin may be used. In one embodiment, the pin can be stored at the retailer and associated with a phone number (or other information) of the consumer. The consumer may be asked to provide his/her phone number each time that the consumer makes a purchase at the retailer. The retailer system can then identify the pin associated with the consumer and combine the pin with the provided telephone number such that the consumer identifier provided to the server 125 is a combination of the of the pin and phone number. The two pieces of information can be combined in any way, including appending the pin to the phone number (or vice versa), performing a mathematical operation between the pin and phone number (where the predetermined operation may be known to server 125), etc. In an alternative embodiment, the consumer may provide the pin to the retailer each time the consumer makes a purchase at the retailer, and the retailer may combine the received pin with a stored phone number (or other information) of the consumer such that the consumer identifier provided to the server 125 is a combination of the pin and phone number.

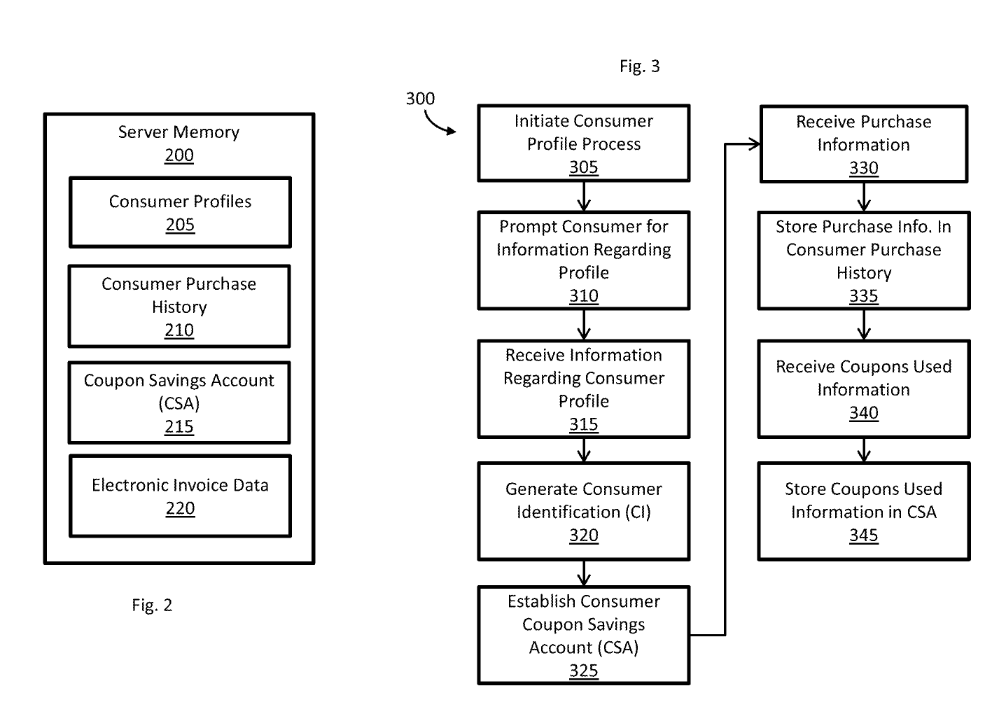

FIG. 2 is a block diagram illustrating a server memory 200 and memory blocks that may exist in the server memory in accordance with an illustrative embodiment. The server memory 200 in FIG. 2 includes consumer profiles 205, consumer purchase history 210, coupons savings accounts (CSA) 215, and electronic invoice data 220. This server memory 200 may be an example of how parts of the memory 130 in FIG. 1 may be allocated.

In the consumer profiles 205 part of the server memory 200, data is stored on the consumers that have signed up for or use the electronic coupon distribution and redemption system. Such information may include a wide variety of information. Several examples of what may be included in a typical consumer profile and stored in the consumer profiles 205 part of the server memory 200 are included herein. As examples, a consumer profile may include the following: (1) an address, such as a home mailing address or a business mailing address; (2) a first name of the consumer; (3) a last name or surname of the consumer; (4) a phone number of the consumer, such as a cell, work, or home phone; (5) one or more dates relevant to the consumer, such as a birthday, anniversary, or date the consumer signed up for the service; (6) an ethnicity of the consumer; (7) an employment status of the consumer, such as unemployed, student, part-time, full-time, seeking, full-time permanent, full-time looking; (8) an annual household income of the consumer or annual income of the consumer; (9) an account password generated by the consumer; (10) an e-mail address with which the system may communicate with the consumer; (11) a gender of the consumer; (12) an age group demographic associated with the consumer, such as an 18-25 year old age group if the consumer is 22 years old, or a 13-17 year old age group if the consumer is 16 years old (alternatively, the system can obtain and keep track of the consumer's age); (13) a marital status of the consumer, such as single, married, divorced, separated, civil union, domestic partnership, etc.; (14) whether the consumer has children, and if so, how many children and the ages and genders of the children; (15) a home ownership status of the consumer, such as renting, own but subject to mortgage, own outright, leasing, leasing with option to buy, dependent domiciled with another, etc.; (16) a dwelling type of the consumer, such as single family home, multi-family home, apartment, condominium, etc. and/or a value of the dwelling; (17) an education level of the consumer, such as no education, some primary education, some secondary education, high school diploma or equivalent, some post-secondary education, associate's degree, trade school certification or degree, bachelor's degree, some graduate level work, master's degree, some post-graduate work, post-graduate degree, etc.; (18) a number of adults living in a household with the consumer; (19) whether the consumer has any pets, including how many, what kinds, and their respective ages; (20) a geographical environment in which the consumer lives; (21) a job function or job title of the consumer; (22) the industry in which the consumer works; and (23) any coupons or types of coupons the consumer desires, such as particular brands or types of items, etc. A consumer's purchase history may also be included in the consumer profiles, but in the embodiment shown in FIG. 2 the consumer purchase history 210 is shown separately from the consumer profiles 210. In this embodiment, an applicable consumer purchase history of a consumer may be linked to that particular consumer's profile.

In the consumer purchase history 210, information is stored regarding a particular consumer's purchases when using the electronic coupon distribution and redemption system. By way of example, Consumer A goes to a hardware store to buy a light bulb and a tape measure. Consumer A in this example has already enrolled in the electronic coupon distribution and redemption system before going to the hardware store. While at the hardware store, Consumer A uses their coupon savings account (CSA) (a detailed discussion of how a consumer uses their CSA is included below) when purchasing the light bulb and tape measure. If the CSA is used, the purchase of the light bulb and tape measure is recorded in the consumer purchase history 210. Several different types of information may be collected based on a purchase. For example, the system may record the time the purchase was made, the types or specific items purchased, the brand of the items purchased, the amount of money spent, the amount of money spent on each item (an average and/or the specific amounts), how the purchase was paid for, what retailer the purchase was made at, and the total quantity of items purchased. This information can be collected regardless of whether a coupon applies to the items purchased. As mentioned above, the consumer purchase history 210 may contain the purchase history of consumers linked to their individual consumer profiles 205, but the consumer purchase history 210 may include additional information as well. For example, the consumer purchase history 210 may include aggregate data on all consumers that are enrolled in the system. The consumer purchase history 210 may also include aggregate data of purchase histories based on specific groups or demographics as defined by the consumer profiles 205. In an alternative embodiment, rather than containing several different lists aggregating data in and from the consumer purchase history 210, the data may be stored in a database that allows for sorting of the data by different criteria. For example, if a system administrator wishes to access the consumer purchase history of one individual consumer, they may do so in one embodiment. As another example, a system administrator may view data for all consumers or a subset of consumers. For example, consumer purchase data may be viewed for all consumer's in the system with an annual household income above $50,000.

The server memory 200 also contains a memory containing data about a consumer's coupon savings account (CSA) 215. The CSA 215 is used to store data about a consumer's available coupons. The CSA 215 may also store data relating to coupons that were assigned to a consumer, but are now invalid and cannot be used. In other embodiments, the coupon would be removed from the CSA when a coupon can no longer be used. A coupon may not be used, for example, if the promotion has ended or if a consumer has already used or redeemed a particular coupon and the coupon is not allowed to be used an unlimited number of times. In this embodiment, the CSA 215 is linked to a particular consumer profile 205. For example, the unique identifier may be the phone number of a consumer. The unique identifier could be other information or combinations of information in the consumer profile 205. In another embodiment, the unique identifier may be a randomly assigned alphanumeric combination. In yet another embodiment, the unique identifier may be a consumer-defined alphanumeric combination, such as a username.

The server memory 200 also contains electronic invoice data 220. The electronic invoice data 220 may include information about the coupon issuer's bank accounts and debit/credit (including Automated Clearing House, or ACH) information. The electronic invoice data 220 may also include similar information about the participating retailer that redeemed a coupon. This information may be used to facilitate reimbursements for discounts taken at the point-of-sale (POS) between the issuer of the coupon and the redeemer of the coupon. Embodiments for such a process will be described below. Additionally, such embodiments may use other electronic invoice data. For example, intermediate bank accounts may be used to facilitate reimbursement. Thus, information relating to those intermediate bank accounts may also be stored in the electronic invoice data 220. These intermediate bank accounts may also be held and/or administered by the server (or owner of the server) that controls or administers the electronic coupon distribution and redemption system. For example, funds for a reimbursement may be transferred from a manufacturer's account to an intermediate account administered by the server. Transferring the funds to an intermediate account may allow the server to verify and track the funds to ensure reimbursement is taking place and that the reimbursement is accurate. After the funds are received into the intermediate account, the funds may then be transferred to the retailer's bank account to reimburse the retailer for redeeming a coupon. A consumer's financial account information may be stored in the electronic invoice data 220. A consumer's financial account information may be used in an embodiment where a coupon does not offer the consumer immediate savings at purchase, but facilitates payment of savings from the coupon issuer directly to the consumer, such as a rebate. Further data stored in the electronic invoice data 220 may include historical invoice data for particular reimbursements, consumers, retailers, or coupon issuers. Like the consumer purchase history 210 and the CSA 215 discussed above, any electronic invoice data 220 relating to purchases and reimbursements by a particular consumer may be linked to that consumer's consumer profile 205.

In an alternative embodiment, the funds transferred may not be exactly for the amount of the discount or coupon. Instead, the funds transferred may be based on the amount of the discount or coupon. For example, the server system may calculate a percentage of the discount to be paid to a third party financial account. Alternatively, the server system may add a set fee as a surcharge instead of a percentage. The server system may also calculate a surcharge using a combination of a set fee and a percentage. The fee may also vary based on the product or service purchased, or the number of coupons in a coupon distribution campaign. This may be done as a payment to whomever is administrating the server system. In one embodiment, the issuer may pay more than the amount of the discount. The server system may then transfer funds to the retailer for the amount of the discount and keep the remaining funds. In another embodiment, the issuer may pay the amount of the discount, and the server system may transfer an amount of funds to the retailer for less than the amount of the discount. In yet another embodiment, the issuer may pay more than the amount of the discount and the retailer may receive less than the amount of the discount.

FIG. 3 is a flow diagram illustrating a method of establishing a consumer profile and consumer Coupon Savings Account (CSA) 300 in accordance with an illustrative embodiment. In alternative embodiments, fewer, additional, and/or different operations may be performed. Also, the use of a flow diagram is not meant to be limiting with respect to the order of operations performed. In an operation 305, a consumer profile process is initiated. The operation 305 may be accomplished by a consumer going to a website for the electronic coupon distribution and redemption system and clicking on a link that begins the creation of a CSA. In another embodiment, the operation 305 may occur after a consumer has downloaded computer instructions for executing the electronic coupon distribution and redemption system, such as downloading an App (or application) on a mobile smart phone. In another embodiment, a consumer may receive an e-mail or other electronic message with a hyperlink in it. The e-mail may be solicited or unsolicited. If a consumer selects the hyperlink, the consumer may be directed to a website hosted on the server. The website may direct the consumer to create a profile or account.

In an operation 310, a consumer is prompted for information to include in his/her consumer profile. This information may include the information listed above that a consumer profile may contain. One prompt may include a question or questions regarding a consumer's preferences for coupons they want to receive. For example, a consumer may indicate a coupon preference for a broad category of product, such as food, cleaning supplies, tools, toiletries, or kitchen ware, or services such as oil changes, pet sitting, spa services, etc. A consumer may also be prompted to indicate more specific coupon preferences. For example, a consumer may indicate that they would like coupons for bread, toilet bowl cleaner, power tools, shampoo, or automatic mixers. In yet another example, a consumer may indicate a coupon preference for coupons issued by a particular manufacturer or related to a particular brand or trade name of a product. As already mentioned, the operation 310 may include many various queries prompting the consumer to enter information for the consumer profile. There may be certain queries that the consumer must respond to in order to set up a profile, while other queries may be designated as optional in order to set up a profile. Additionally, in another embodiment, the Send Queries Regarding Consumer Profile may be returned to later in order for the consumer to complete queries that were designated as optional that the consumer did not complete when originally setting up a consumer profile.

In an operation 315, the server or system receives information from the consumer in response to the queries outlined above. In various embodiments, a consumer may enter this information in many different ways including through a smart phone application, an internet browser, a dedicated computing system set up at retailers to establish consumer accounts, or even concurrent with a purchase. In the embodiment where operation 315 occurs concurrent with a purchase, information may be input through a cash register or other retailer device designed to collect such information. For example, if a transaction is completed through a tablet (or other retailer device) with a credit card swiping plug-in, the consumer may be prompted to set up an account and the information about a consumer (e.g., information used to generate a consumer profile) may be entered on the tablet or other retailer device. In one embodiment, the consumer may only be prompted to enter an e-mail address. The system may then use the e-mail address to send an e-mail to the consumer, which may include a hyperlink that directs the consumer to a web page that initiates the consumer profile creation process. In another embodiment, some information may not have to be entered by a consumer in this scenario because the tablet may automatically retrieve a consumer's name, address, and other pertinent information for the profile from the information associated with the credit card used to make the purchase.

In an operation 320, a unique consumer identifier (CI) is generated and associated with the consumer profile. As discussed previously, such a unique identifier may be used for various purposes, including linking a consumer profile to various purchases and purchase histories, linking a consumer profile to a coupon savings account (CSA) so that a consumer can successfully redeem coupons at a retailer, and link electronic invoice data to a consumer profile. In various embodiments, the CI may not be used for all of these purposes. For example, a CI may be used when a consumer is making a purchase to identify the CSA of the customer. The CI may not necessarily be used to link the CSA to consumer profiles, electronic invoice data, purchase histories, etc. In one embodiment, the CI may be the consumer's mobile telephone number. In another embodiment, the CI may be randomly generated. In yet another embodiment, the CI may be akin to a username or password that is defined and input by the consumer.

In an operation 325, an actual CSA is established for the consumer. One embodiment of this may utilize a server memory 200 as demonstrated in FIG. 2. For example, the CSA may be established in the CSA 215 portion of the server memory 200. The information received in operation 315 may be stored in the consumer profiles 205. After operation 325, a consumer profile may be available for a coupon issuer to view such that the coupon issuer is able to issue coupons to the consumer. To do so, a coupon issuer may issue coupons to a consumer's CSA based on certain criteria in the consumer profile. The process of selecting a particular CSA to receive a coupon is discussed below.

If a coupon has been issued to a consumer CSA, the coupon may be eligible for redemption by the consumer. The consumer may proceed to a retail store and make a purchase. Upon identification of the consumer's CI, the system will receive purchase information regarding the consumer's purchase in an operation 330. The system may determine whether any coupons in the CSA apply to the consumer's purchase.

In an operation 335, the system may record the purchase and store it in the consumer purchase history. This information may be stored in, for example, the Consumer Purchase History 210 described above with reference to FIG. 2. The system may also receive information that applicable coupons were used at an operation 340, where information is received about what coupons have been used by a consumer. For example, the system originally receives purchase information. The system may then send back to the retailer any applicable coupons and the amounts of the discount that applies. The system may then receive further information that the discount was applied for the purchase and the coupon was actually used. If information is transmitted in operation 340, then the coupons used are stored at Store Coupons Used Information in CSA 345. Here, the coupons applied are noted in the consumer's CSA. This is helpful for tracking consumer spending, and for determining whether the presence of a coupon may have helped incentivize the purchase of a particular item. Further, the system may identify whether the consumer had viewed the coupon via a consumer's device before making the purchase (i.e., whether the consumer was aware that the coupon was available to him/her). Such information may also be stored. Additionally, if a coupon issuer has set some sort of limit for the number of coupons to be redeemed generally or per customer, the fact that a coupon has actually been used may be important to store in the CSA.

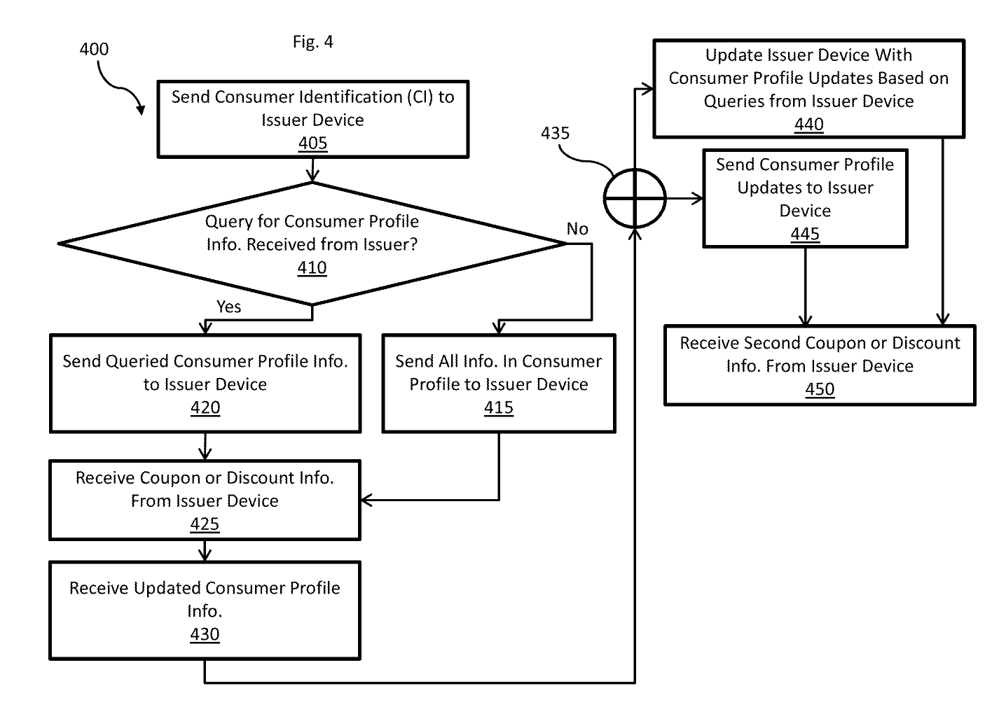

A coupon issuer (or potential coupon issuer), may seek to initiate a coupon distribution campaign. To do so, a coupon issuer may use a software interface to specify certain consumers to be targeted in the campaign. For example, a manufacturer may specify that they would like to target residents of Florida and California for coupons relating to beach towels. A different manufacturer may seek to target residents of Wisconsin, Minnesota, and Michigan when marketing coupons for snow removal equipment. In another example, an airline may wish to target university students for plane ticket promotions during the spring. In another example, a manufacturer of cheese head hats may wish to target consumers who have identified in their consumer profile that they are fans of the Green Bay Packers. In another example, an issuer that seeks to sell double chocolate chunk cookies may target consumers that have bought other types of chocolate cookies in the past. The system may identify the cookie purchasing consumers from each consumer's purchase history. In another embodiment, a consumer may have indicated a coupon preference for receiving certain types of coupons. For example, a consumer may have specified a coupon preference to receive coupons relating to toilet paper. As such, a toilet paper manufacturer may choose to target any consumer that has indicated a coupon preference for receiving coupons relating to toilet paper. In an alternative embodiment, the system may automatically route a coupon regarding toilet paper to any consumer that has indicated a coupon preference in toilet paper coupons, even if the issuer has not specified that the coupon be routed based on the consumer's indicated coupon preferences. In another embodiment, a plumbing company based in Gainesville, Ga. may seek to target any consumer that lives within fifty miles of Gainesville, Ga. and owns their home. An issuer may also specify information regarding the coupon distribution campaign, such as the discount offered, limits on coupon redemption, and a date range that the coupons will be valid. In an alternative embodiment discussed below with reference to FIG. 4, an issuer may select consumers based on their consumer profiles as opposed to merely specifying criteria for consumers that are to be included in a coupon distribution campaign.

FIG. 4 is a flow diagram illustrating a method of providing consumer profile information to a coupon issuing-device 400 in accordance with an illustrative embodiment. In alternative embodiments, fewer, additional, and/or different operations may be performed. Also, the use of a flow diagram is not meant to be limiting with respect to the order of operations performed. In an operation 405, a consumer identifier (CI) is sent to an issuer computing device, such as a personal computer (PC), laptop, tablet, smart phone, or other computing device. In another embodiment, this element may not be performed, as an issuer device may want to query consumer profile information generally as opposed to one particular consumer profile. As just one example, an issuer may request consumer profiles or parts of consumer profiles of all people living in Madison, Wis. In another embodiment, an issuer may request consumer profiles of all people who are interested in coupons for a product which the issuer manufactures. In an operation 410, the system may determine whether a specific request for information about a consumer profile has been received from an issuer device. If a particular query from the issuer device is not received, the system may proceed to an operation 415, where all information in a consumer profile is sent to an issuer device. In operation 415, all or a portion of the information in a consumer profile may be sent to an issuer device for viewing by the coupon issuer. In another embodiment, operation 415 may just allow the issuer device to access all of a consumer profile, rather than actually transmitting all of the consumer profile to the issuer device.

If there is a query from the issuer device for particular information or to apply a particular filter, then the system proceeds to Send Queried Consumer Profile Info. to Issuer Device 420. Here, an issuer device may query or sort consumer profiles for certain categories or demographics. For example, an issuer may desire to isolate all consumer profiles that are male and have expressed a coupon preference for coupons regarding sporting goods. If such a query is received, the relevant data may be provided to the issuer device at Send Queried Consumer Profile Info. to Issuer Device 420.

After operation 420 or operation 415, the system proceeds to an operation 425. At operation 425, an issuer sends information relating to a coupon or discount and information relating to who they would like to issue the coupon and the information is received at the server. In further embodiments, the information from the issuer may also include whether or not to limit the number of coupons that can be redeemed by retailers and consumers. For example, an issuer may set an overall maximum on number of coupons that can be redeemed. In another example, the issuer may set the maximum number of coupons to be redeemed based on a limit per customer, limit per retailer location, limit based on geographic area, or other demographic limit based on information in consumer profiles.

In another embodiment, an issuer may set a minimum number of coupons that should be redeemed before a discount can be applied or reimbursed for a particular distribution or promotion. In such an embodiment, the issuer may prefer that a minimum number of products or services be sold for the coupon distribution campaign to be successful and/or profitable. As such, an issuer may specify a minimum number of coupons that must be redeemed. In one embodiment, a coupon added to a consumer's CSA will specify that a minimum number of coupons must redeemed for the discount to apply. In such an embodiment, the consumer may not receive the discount when purchasing the product initially if the minimum has not yet been met. If the consumer does not know about the particular campaign, he/she may not even realize the discount for the coupon has not been applied at purchase. If the minimum is later reached, the system may reimburse the consumer for the discount that was not originally replied. This reimbursement may be using funds from the coupon issuer. In such an embodiment, the retailer may not have to be reimbursed for the coupon because the retailer received full price for the product or service when the product or service was originally purchased by the consumer. In an alternative embodiment, an issuer may set a minimum for a coupon distribution campaign, but the consumer may receive a discount at the time of purchase. In this embodiment, the retailer may redeem the coupon even if the minimum has not yet been met. In this embodiment, a retailer may bear the risk that the minimum coupon redemption threshold may not be met. If the threshold is eventually met, then the retailer would receive the reimbursement from the manufacturer. In this embodiment, there may be added incentive for the retailer to market or promote the product or service that is the subject of the coupon distribution campaign.

After time, a consumer may wish, or may be prompted, to update their consumer profile. Such information may be received at an operation 430. The system may then proceed in at least two different ways at operation 435. First, the system may proceed to operation 440, where an issuer device is updated with consumer profile updates based on queries from an issuer device. Here, updates to consumer profiles are disseminated to issuers as they perform further queries of consumer profile data. As a second option, the system may proceed to an operation 445, where consumer profile updates are sent to an issuer device automatically. In this embodiment, an issuer is automatically updated with changes in a consumer profile. In another embodiment, an issuer may prefer a hybrid approach. In other words, an issuer may prefer to be automatically updated with certain consumer profile changes and not others. For example, if the issuer sells baked goods and a consumer updates their coupon preference data to include a preference for chocolate chip cookie coupons, such an update may be of particular interest to the issuer. In contrast, an issuer that sells baked goods may not have a particular interest in a consumer profile update that reflects a consumer acquiring a new pet cat. In yet another embodiment, the system may not necessarily send updates to consumer profiles to an issuer device at all, instead allowing the issuer device to simply specify targets for their coupon distribution campaigns.

At an operation 450, the system may receive a second coupon or discount information based on the updated consumer profile information. In other words, a new coupon distribution may be tailored to the queries of an issuer device based on the updated consumer profile information, regardless of whether the information was sent to the issuer. In another embodiment, the second coupon or discount information may be an update to the first coupon or discount information, where the update is based on the updated information in the consumer profiles.

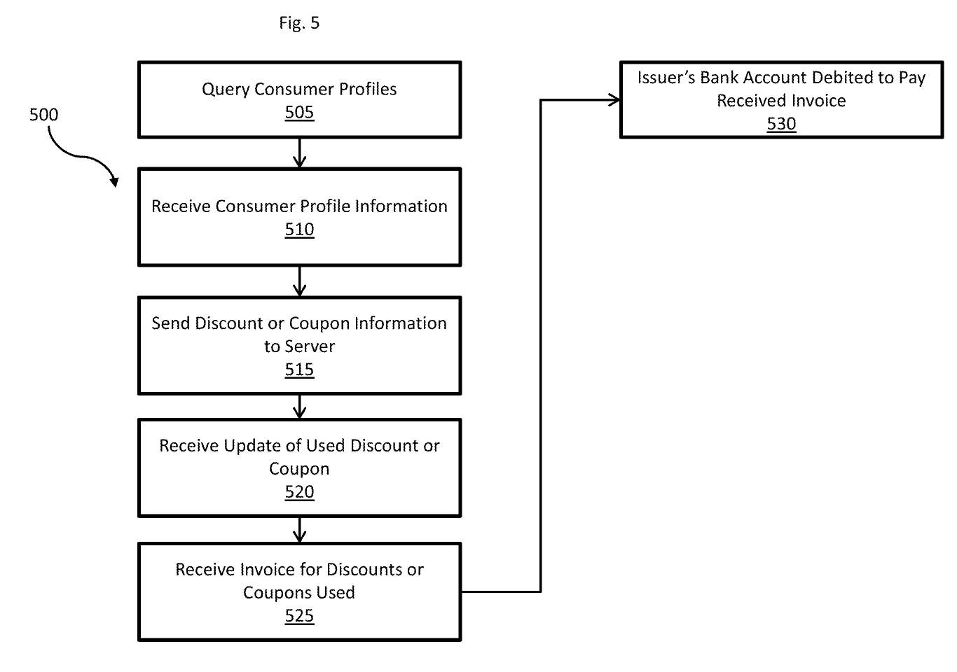

FIG. 5 is a flow diagram illustrating a method of acquiring consumer profile information from a server and issuing coupons 500 in accordance with an illustrative embodiment. In alternative embodiments, fewer, additional, and/or different operations may be performed. Also, the use of a flow diagram is not meant to be limiting with respect to the order of operations performed. In an operation 505, an issuer device sends a query to a server to determine consumer profiles to target for a coupon distribution campaign. In an operation 510, the issuer device receives the consumer profile information that it queried at operation 505.

At an operation 515, the issuer device sends the desired coupon or discount information to the server. Here, the coupon information may include several types of information. For example, the information may include the applicable products for the coupon, the discount to be applied, and identifying information so that when coupon is redeemed the retailer can be adequately compensated for applying the discount based on the coupon. Other information may include limits on number of coupons that can be redeemed. More information that may be included are the CSAs that the coupons and discounts that should be applied based on the query of consumer profiles at operation 505.

If a coupon is actually used by a consumer, the issuer device may then receive an update that a coupon has been used at an operation 520. This may be beneficial to an issuer of coupons. An issuer may track real-time, or near real-time, the success of their coupon distribution. For example, an issuer may know how many coupons in a campaign have been redeemed, how many coupons have been redeemed in particular areas, and issuers may figure out if there are certain demographics or consumer profile characteristics that the coupon distribution campaign is more or less successful with.

In addition to an update that a coupon has been used, the issuer device may also receive an invoice for discounts or coupons used at an operation 525. The invoice may be a payable invoice, indicating the amount of money that will be deducted from the issuer's bank account in order to reimburse the retailer for applying a coupon or discount to a consumer purchase. In an operation 530, the coupon issuer's bank account has the value of the coupon subtracted from its account. In one embodiment, this process may be executed using Automated Clearing House (ACH) transactions. ACH transactions use a bank routing number and an account holder account number to electronically route funds from one bank account to another. Other embodiments may use other payment methods. For example, a credit transaction, check, money order type transaction, or a pre-funded account similar to that of a gift card may be used to reimburse a retailer for redeemed coupons.

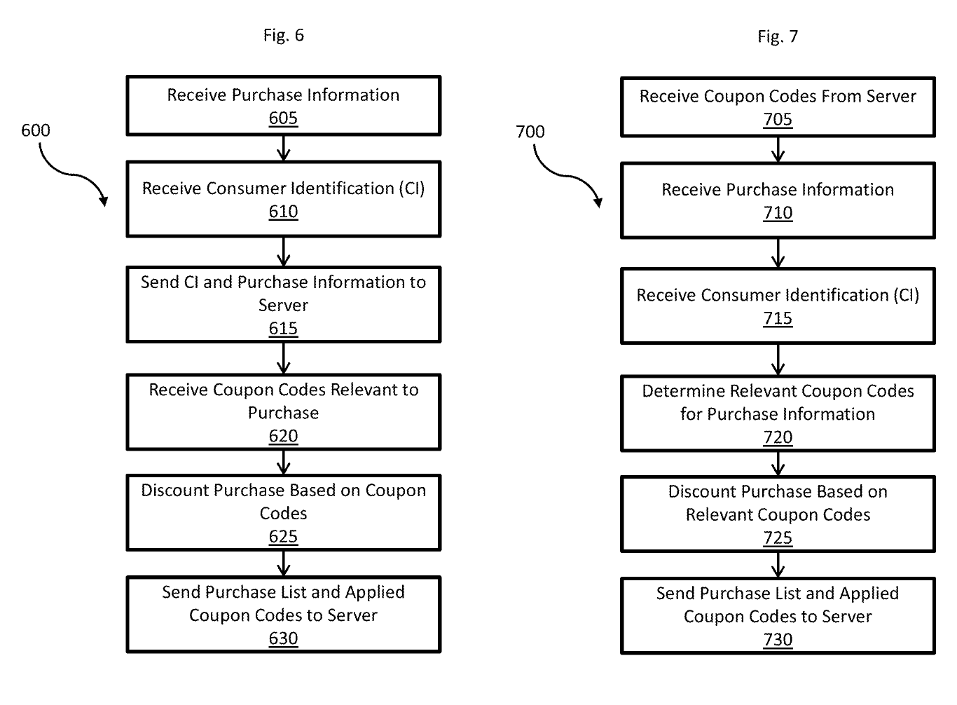

FIG. 6 is a flow diagram illustrating a method for discounting a purchase based on digital coupons 600 in accordance with an illustrative embodiment. In alternative embodiments, fewer, additional, and/or different operations may be performed. Also, the use of a flow diagram is not meant to be limiting with respect to the order of operations performed. At an operation 605, a retailer device receives information relating to the items a consumer wants to purchase. This may occur by scanning bar codes on the products, manually typing in bar codes from the products, selecting the products from a list of products, or other similar method that allows the retailer device to identify what items are being purchased. At an operation 610, the retailer device receives the CI that corresponds to a consumer profile, CSA, and consumer purchase history. As noted above, this may be a phone number, username, password, randomly assigned identifier, etc. The CI may be received in a variety of ways. For example, a cashier at a retail store may ask the consumer to provide his/her CI. The cashier may then manually enter the CI into the retail device. In other embodiments, wireless communications such as RFID, near field communication technologies, Bluethooth, etc. may be used to communicate the CI to the retailer device.

The retail device then performs an operation 615, which sends information regarding an attempted purchase by a consumer and the consumer's CI. At an operation 620, the retail device has received back from a system server what items need to be discounted and the amount of the discounts to be applied. At an operation 625, the discounts based on the applicable coupons are applied to the purchase price. When discounts are applied to the purchase price, a consumer's bill will be reduced. At an operation 630, information regarding the actual purchase and coupons applied for the purchase is sent to the system server.

FIG. 7 is a flow diagram illustrating a second method for discounting a purchase based on digital coupons 700 in accordance with an illustrative embodiment. In alternative embodiments, fewer, additional, and/or different operations may be performed. Also, the use of a flow diagram is not meant to be limiting with respect to the order of operations performed. At an operation 705, the retailer device receives coupon codes and associated coupon information (such as the amount of discount that applies to a particular coupon) from a server. In this embodiment, the retailer device may store information on several coupons. This may decrease the amount of data that is transferred between a retailer device and a server during a transaction, and thereby increasing the speed with which a transaction may be completed. At an operation 710, a retailer device receives information on the items a consumer wants to purchase. This may occur by scanning bar codes on the products, manually typing in bar codes from the products, selecting the products from a list of products, or other similar method that allows the retailer device to identify what items are being purchased.

At an operation 715, the retailer device receives the CI that corresponds to a consumer profile, CSA, and consumer purchase history. As noted above, this may be a phone number, username, password, randomly assigned identifier, etc. In another embodiment, a consumer identifier (CI) that is an alphanumeric string may not be used at all. For example, in the case of a near field communication application, the system may identify the CSA through a wireless signal. This signal may be unique and represent a particular consumer CSA. In another embodiment, the signal may communicate a CI. Devices that communicate with a POS device may indicate a CSA in a variety of ways, not all of which include an actual CI. The CI may be received in a variety of ways. For example, a cashier at a retail store may ask the consumer their phone number. The cashier may then manually enter the phone number into the retail device. In other embodiments, wireless communications such as RFID, near field communication technologies, Bluetooth, etc. may be used to communicate the CI to the retailer device.

At an operation 720, the retailer device compares the purchase information (such as the particular items sought to be purchased) to the coupon codes received from the server at operation 705, which may have also been stored at the retailer device at operation 705. If there are relevant coupon codes, the retailer device will discount the purchase price based on the relevant coupon codes at an operation 725. At an operation 730, information regarding the actual purchase and coupons applied to the purchase is sent to the system server.

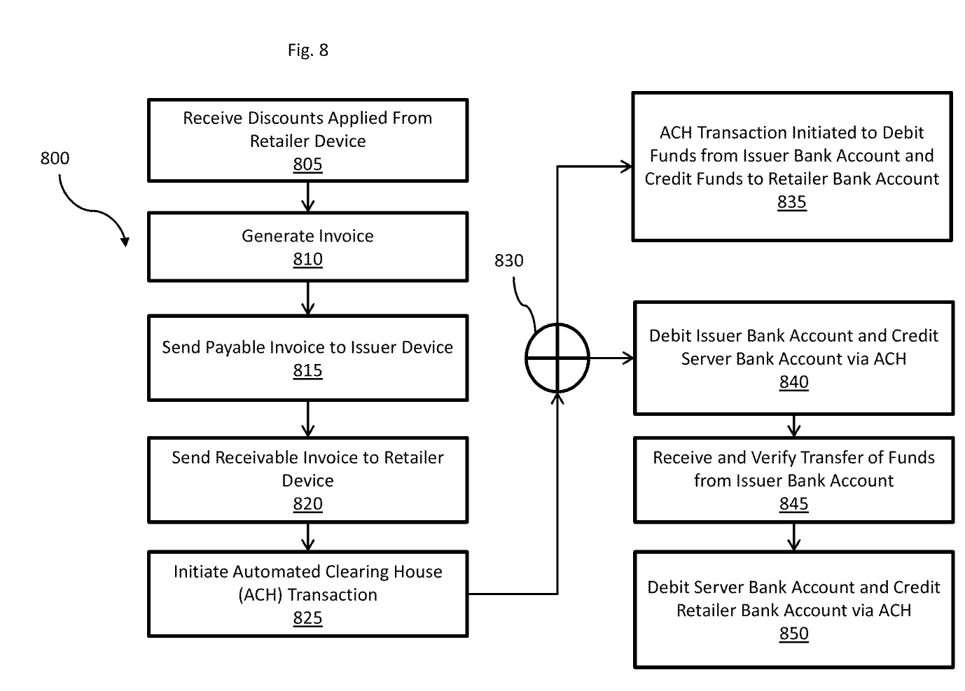

FIG. 8 is a flow diagram illustrating a method for issuing payments from a coupon issuer to a retailer based on purchases using coupons 800 in accordance with an illustrative embodiment. In alternative embodiments, fewer, additional, and/or different operations may be performed. Also, the use of a flow diagram is not meant to be limiting with respect to the order of operations performed. At an operation 805, the system server receives information regarding the coupons, coupon codes, and/or discounts applied to a purchase by a retailer. The system uses this information to determine the amount of funds that should be paid from an issuer of a coupon to a retailer that redeemed the coupon. Once that total is calculated, the system generates an invoice at an operation 810. The invoice represents the amount of money that is to be paid from the issuer to the retailer. The invoice may represent one redeemed coupon, but may often represent several redeemed coupons, even coupons of different types. Since the system may receive information relating to many different purchases and coupons, it may simplify invoicing and allow a coupon issuer to see all of their outgoing reimbursements to a variety of retailers on one invoice. Similarly, a retailer may receive an invoice that shows all payments from various coupon issuers that will be made to the retailer, which may simplify accounting and understanding of coupon reimbursements and invoices. Such invoices (either sent to the issuer or the retailer) may cover a set amount of time. For example, invoices may be generated daily, weekly, bi-weekly, monthly, bi-monthly, or even yearly. In another embodiment, an invoice may be generated instantaneously whenever discounts applied from a retailer device are received at operation 805.

Once the invoices are generated at operation 810, the system may send a payable invoice to an issuer device at an operation 815 and send a receivable invoice to a retailer device at an operation 820. At an operation 825, the system initiates the actual reimbursement process by initiating an automated clearinghouse (ACH) transaction. In other embodiments, different payment methods may be used. For example, a credit transaction, check, money order type transaction, or a pre-funded account similar to that of a gift card may be used to reimburse a retailer for redeemed coupons.

At operation 830, two alternate paths may be taken to process the ACH reimbursement payment. In one embodiment, the system will use an ACH transaction that is initiated to debit funds from an issuer bank account and credit funds to a retailer bank account at operation 835. Here, the funds may be moved directly from a coupon issuer's account to the retailer's account. This may help reduce the time that it takes for a retailer to be reimbursed. It may also help reduce fees associated with multiple ACH transactions.

In another embodiment, the system will debit an issuer bank account and credit a server bank account via an ACH transaction in operation 840. Here, the server bank account may be administrated or controlled by those administrating and controlling the electronic coupon distribution and redemption system. When the reimbursement funds pass through the server account, it may also make verifying that the funds have been paid from the issuer to the retailer easier. The server may then know exactly when an issuer has paid an invoice and exactly when a retailer receives payment for a given invoice. Further, this may allow the server to track when an issuer is unable or unwilling to pay if, for example, issuer's bank account has a lack of funds to reimburse retailers for redeemed coupons. Indeed, at an operation 845, the server verifies and checks that the payment is properly received from the issuer. Additionally, server compares the payment received against invoices issued to verify that the payment is correct and what retailer the payment will go to. Alternatively, the verification may not be performed. At an operation 850, the reimbursement funds are debited from the server account and deposited into the retailer account. These funds reimburse a retailer for discounting retail products on behalf of coupon issuers.

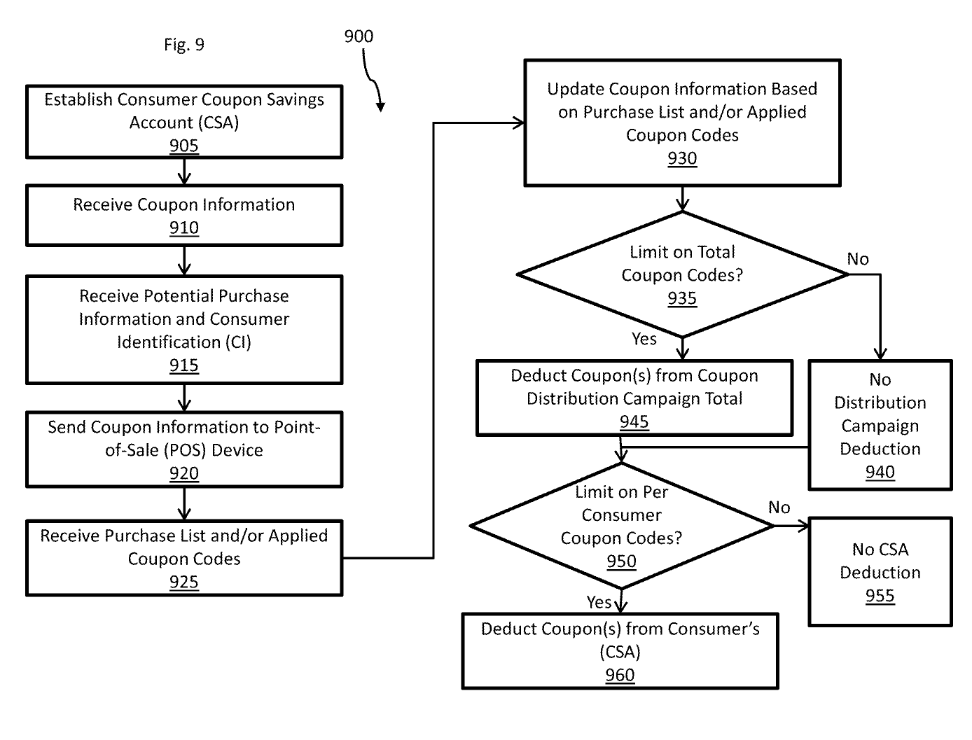

FIG. 9 is a flow diagram illustrating a method for updating a coupon distribution campaign and consumer Coupon Savings Account (CSA) based on purchases using coupons 900 in accordance with an illustrative embodiment. In alternative embodiments, fewer, additional, and/or different operations may be performed. Also, the use of a flow diagram is not meant to be limiting with respect to the order of operations performed. At an operation 905, a consumer coupon savings account (CSA) is established. Discussion of varying embodiments for establishing a CSA can be found above. At an operation 910, information regarding distributed coupons may be received. The coupon information may include several types of information. For example, the information may include the applicable products for the coupon, the discount to be applied, and identifying information so that when the coupon is redeemed the retailer can be adequately compensated for applying the discount based on the coupon. Other information may include limits on number of coupons that can be redeemed. More information that may be included are the CSAs that the coupons and discounts should be applied to per a query of consumer profiles. In this embodiment, a relevant portion of information is whether there are limits on the number of coupons that can be redeemed.

At operation 915, the server receives, from a retailer device, a CI and an indication that the consumer associated with the CI is attempting a purchase at a retail store. The server can then search its memory for coupons that may apply to the potential purchase. If the server finds any applicable coupons, the system Sends Coupon Information to Point-of-Sale (POS) Device in an operation 920. Here the applicable coupons, codes, etc. are sent to the retailer device to apply to the purchase.

At an operation 925, the server receives confirmation that the items were purchased from the retailer device and what, if any, coupons were applied to the purchase. Upon receipt of this information the system may update a coupon distribution campaign information based on the purchase list and/or applied coupon codes at an operation 930. In other words, information based on the usage of coupons may be updated. For example, if a coupon distribution campaign has a maximum number of coupons, the amount of available coupons will be decreased if one of the coupons was redeemed in the purchase. Many coupon campaigns may be distributed with limits for individuals, stores, or total redemptions. The system determines if there is a limit on total coupon codes at an operation 935. If there is a limit on total coupon codes, then the redeemed coupon is deducted from a coupon distribution campaign total at an operation 945. Additionally, although not shown in FIG. 9, a coupon may also be removed from a consumer's CSA once it is redeemed, particularly if there is a limit on total coupon codes to be issued. If there is no limit on total coupon codes allowed for a distribution campaign, there is no deduction performed at operation 940.

At an operation 950, the system determines if there is a limit set on the number of coupons in a certain campaign or distribution that can be redeemed by a particular consumer. If there are not per consumer limits, then no CSA deduction occurs at an operation 955. If there are per consumer limits, the system will deduct the coupon(s) from the consumer's CSA at an operation 960.

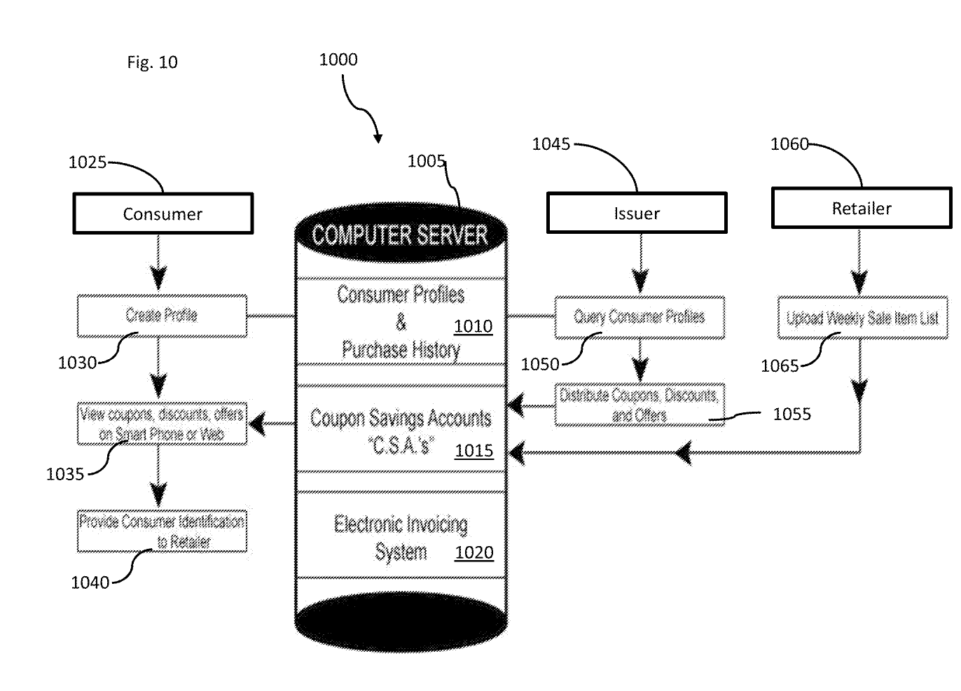

FIG. 10 is a process flow diagram demonstrating a coupon distribution method 1000 in accordance with an illustrative embodiment. In alternative embodiments, fewer, additional, and/or different operations may be performed. Also, the use of a flow diagram is not meant to be limiting with respect to the order of operations performed. In the coupon distribution method 1000, a consumer 1025 creates a profile 1030 on a website hosted on a computer server 1005. Various embodiments on how a consumer may create a profile are disclosed herein. The consumer profile is stored in the computer server 1005 in a consumer profile and purchase history memory 1010. A coupon savings account (CSA) 1015 is also established for the consumer 1025 on the computer server 1005.

A retailer 1060 uploads a weekly sale item list 1065 to a consumer's CSA 1015 using a software application on a web site hosted on the computer server 1005. In some embodiments, all coupons related to the weekly sale item list 1065 will be added to the consumer's CSA 1015. In other embodiments, only coupons on the weekly sale item list 1065 that a consumer 1025 has demonstrated a preference for will be added to the consumer's CSA 1015. Such a coupon preference may be demonstrated by the consumer 1025 specifying a coupon preference when creating or updating their consumer profile 1010. In other embodiments, a coupon preference may be demonstrated by the consumer 1025's purchase history 1010.

An issuer 1045 may perform a query on consumer profiles 1050 of all consumer CSA 1015 and consumer profiles and purchase histories 1010 to identify consumers 1025 that meet particular goals of a coupon issuer 1045's coupon distribution campaign. Such a query may be accomplished through a software application on a web site hosted on the computer server 1005. Note that queries can mine one, some, or all of the consumer profiles and purchase history 1010 and the CSAs 1015. As one example of a query of a consumer profile 1050 that may be performed by an issuer 1045, the issuer 1045 may query to identify consumers 1025 where: (1) the consumer 1025 is female; (2) the consumer 1025 is between 18 and 45 years old; (3) the consumer 1025 has never purchased issuer 1045's product before; (4) the consumer 1025 is employed; (5) the consumer 1025 has an annual household income between $50,000 and $85,000; (6) the consumer 1025 has children; (7) the consumer 1025 owns a home; and (8) the consumer lives in the zip code 60616. Once all consumers 1025 meeting the desired criteria are specified, the issuer 1045 creates a coupon distribution campaign using a software application on a web site hosted by the computer server 1005. Once the coupon distribution campaign is created, the issuer 1045 may distribute coupons, discounts, and offers 1055 to all of the consumer CSAs 1015 where a consumer profile 1010 matches the performed query of consumer profiles 1050.

In other embodiments, many different types of information may be queried by an issuer. For example, a query may attempt to target consumers in a particular region, city, state, or zip code. Other inquiries may attempt to target consumers who shop at a particular store, or who live within a certain proximity of a store. In other embodiments, a retailer, not just an issuer, may access consumer data and perform queries to target distribution of weekly sale item lists. In other words, a retailer may take the role of the issuer and the retailer in any of the embodiment disclosed herein. A retailer may also create custom lists that are to target certain demographics or consumers with particular purchasing histories. For example, a consumer who normally buys food and clothing may not be targeted with weekly sale item lists that include hardware sales. Similarly, a consumer who has no children may not be targeted with weekly sale item lists that include children's clothing.

A consumer 1025 may view available coupons, discounts, offers, etc. on a smart phone or on a website 1035. The available coupons are ones that have been added to or assigned to the consumer 1025's CSA 1015. Available coupons may include coupons from the issuer 1045 and/or the retailer 1060. The consumer 1025 may also shop for items for purchase at the retailer 1060. When the consumer 1025 checks out to purchase the items, the consumer 1025 provides the consumer identifier (CI) 1040 to the retailer 1060. The CI may be manually entered into the retailer 1060's POS device or it may be scanned or otherwise sensed by the retailer 1060's POS device.

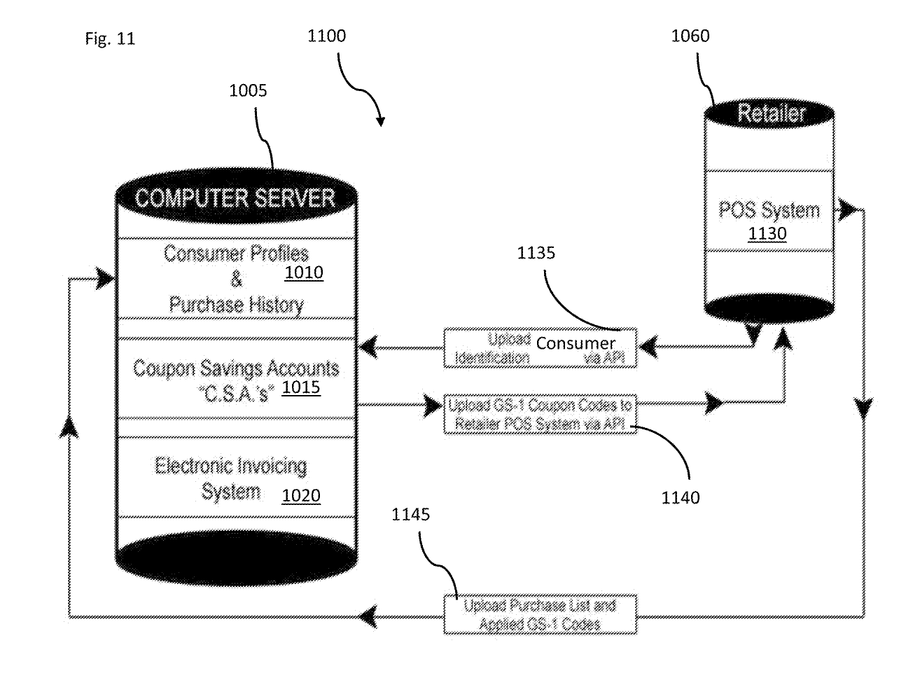

FIG. 11 is a process flow diagram demonstrating a coupon redemption method 1100 in accordance with an illustrative embodiment. In alternative embodiments, fewer, additional, and/or different operations may be performed. Also, the use of a flow diagram is not meant to be limiting with respect to the order of operations performed. At the retailer 1060, there is a POS system 1130. The POS system 1130 uploads the CI via an application programming interface (API) to the computer server 1005 containing the CSAs 1015. Coupon codes associated with the CI and stored within the CSA 1015 are uploaded to the retailer's POS system 1130 via the API at element 1140. In this embodiment, the coupon codes are GS-1 coupon codes. GS-1 is a standard format for coupon codes. Other standards and protocols than GS-1 may be used in other embodiments. Where a product or products being purchased have an associated coupon, the GS-1 code and its associated discount are electronically applied to the transaction total by the POS system 1130.

Once the consumer has paid for the items being purchased and the sale is tendered, the transaction details including the consumer's purchase list and all applied GS-1 codes are uploaded to the computer server 1005 via the API at element 1145. This information is stored as part of the consumer profile and purchase history 1010. Although GS-1 codes may be used in some illustrative embodiments, GS-1 coupon codes are by no means necessary to practice many embodiments. Other coupon standards may be used. Additionally, coupons may be defined using product codes such as a UPC (universal product code) number or SKU (stock keeping unit) number.

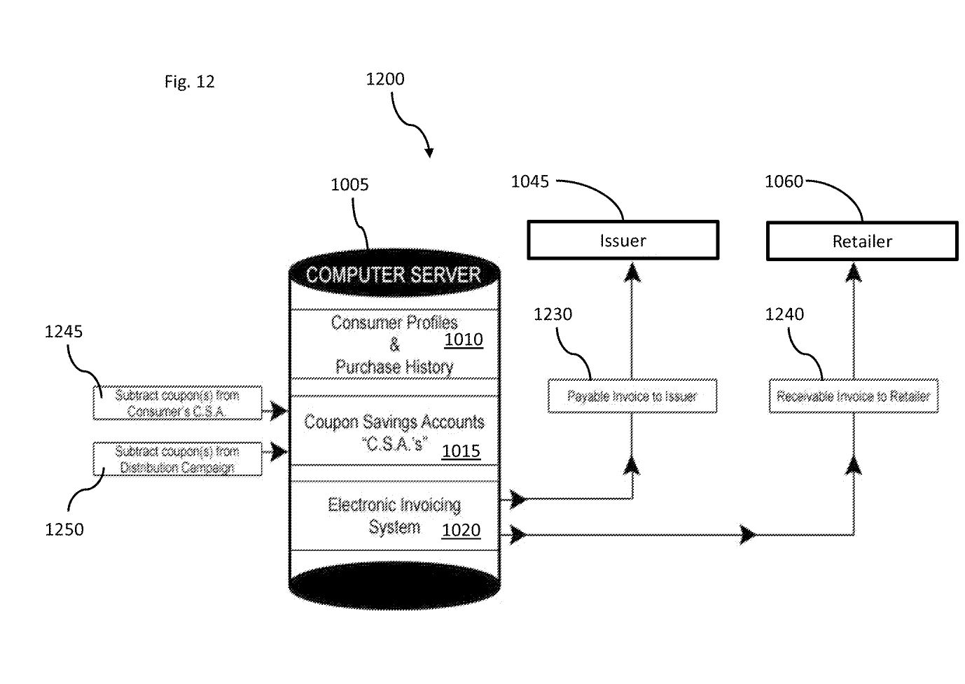

FIG. 12 is a process flow diagram demonstrating an invoice generation associated with a coupon reimbursement method 1200 in accordance with an illustrative embodiment. In alternative embodiments, fewer, additional, and/or different operations may be performed. Also, the use of a flow diagram is not meant to be limiting with respect to the order of operations performed. Any coupons redeemed by a consumer are subtracted from the consumer's CSA 1015 at element 1245. A redeemed coupon is also subtracted from the distribution campaign at element 1250, where the total number of available coupons in the distribution campaign is reduced by one. The electronic invoicing system 1020 is also utilized on the computer server 1005 to electronically generate a payable invoice 1230 to the issuer 1045 for the coupon redeemed by the consumer. The electronic invoicing system may also electronically generate a receivable invoice 1240 to the retailer 1060. These invoices may be sent electronically such as e-mail or text message, or may also be sent for printing and physical mail. In another embodiment, a fax including the invoice may also be sent to the issuer 1045 of the retailer 1060.

A coupon distribution campaign may be defined by an issuer in many ways. For example, the issuer may define how long the campaign will last, or the duration. The issuer may also determine a maximum number of coupons that may be redeemed in total and a maximum number of coupons that may be redeemed by a particular consumer. In one embodiment, an issuer may also determine that a certain minimum number of coupons must be redeemed for a reimbursement to be sent to a retailer. In such an embodiment, a retailer may have additional incentive to help promote the campaign, since the retailer may risk not being reimbursed if the minimum coupon redemption threshold is not met. A distribution campaign may also be further defined by an issuer with special redemption rules. For example, a consumer may need to buy multiple items in order to qualify for the coupon, such as a buy two, get one free sale. A distribution campaign may also define particular retail outlets where an offer is valid. A distribution campaign may further define the benefit to the consumer, such as how much money off a product may be if the coupon is redeemed. An issuer may also define a start date for the campaign. Defining a start date for the campaign may be worthwhile if the campaign is not to start on the day the campaign is created in the system. In another embodiment, a coupon issuer may define that a coupon may only be redeemed if a particular payment method is used by the consumer. For example, the campaign may stipulate that to qualify for the coupon a certain brand of credit or debit card be used to make the purchase. In another embodiment, the campaign may stipulate that a credit or debit card issued by a particular financial institution should be used to make the purchase. In such embodiments, if the consumer fails to meet the condition, the coupon may not be redeemed and the discount may not be applied to the consumer's purchase.

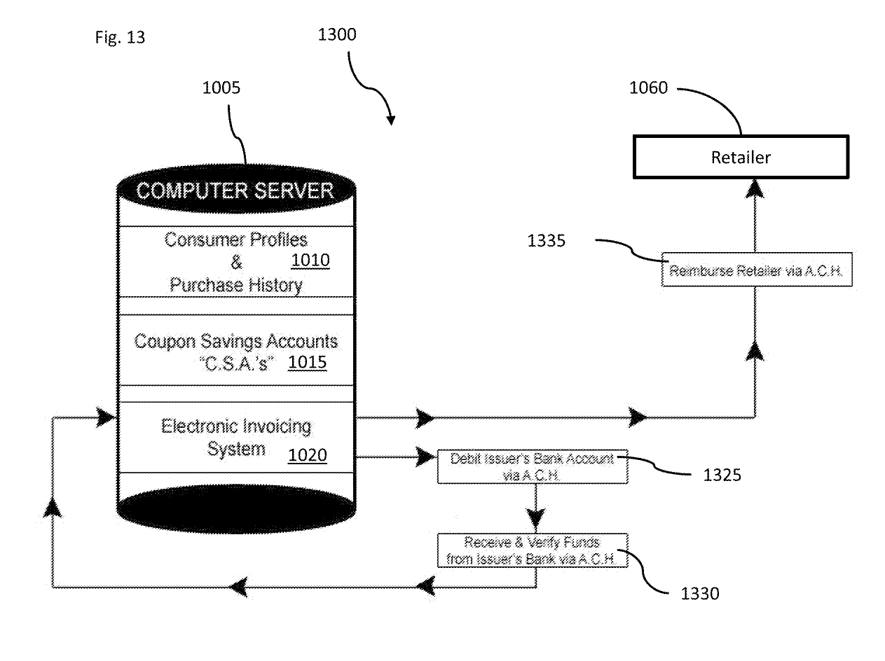

FIG. 13 is a process flow diagram demonstrating a financial transaction associated with a coupon reimbursement method 1300 in accordance with an illustrative embodiment. In alternative embodiments, fewer, additional, and/or different operations may be performed. Also, the use of a flow diagram is not meant to be limiting with respect to the order of operations performed. The electronic invoicing system 1020 on the computer server 1005 also electronically debits an issuer's bank account via an ACH transaction at 1325. The debited funds may be received and verified from issuer's bank via an ACH transaction at 1330. The funds may be reimbursed to the retailer 1060 that processed the original transaction that redeemed a coupon at 1335.

Reimbursements for redeemed coupons may happen in a variety of ways. For example, funds may be totaled and debited/credited weekly. Other time frames are possible. Fund transfers may also happen concurrently or relatively concurrently with the generation of invoices. In other embodiments, the fund transfers and generation of invoices will not happen concurrently. For example, the generation of invoices for redeemed coupons may happen daily, while the transfer of funds to reimburse redeemed coupons may happen weekly. Other varying time periods are also contemplated.

In an illustrative embodiment, a client-device may perform some of the functions and steps performed by other devices in the embodiments disclosed above. For example, a client-device may be a PC, tablet, smart phone, etc. In such an embodiment, a client-device may receive from a retail-device a list of goods/services the consumer is attempting to purchase at a retailer. In another embodiment, the consumer may input into the client-device the items the consumer is attempting to purchase at the retailer. This input may be done by the consumer manually entering or selecting products using a software interface, or it may include scanning a bar code or UPC and acquiring information on the purchased items using the UPC. Once the items attempted to be purchased are input or identified by the client-device, the client-device may interface with a server to determine coupons for which the consumer is eligible. If the consumer is eligible for particular coupons, the client-device may calculate a discount to apply based on the coupons and communicate that discount to the retailer-device. In another embodiment, the client-device may also calculate the total to be paid by the consumer to the retailer for the items being purchased. In such an embodiment, the client-device would also communicate the total to be paid to the retailer-device. In still another embodiment, a client-device may be periodically updated by the server with information regarding coupons that have been issued to the consumer. Thus, when a consumer goes to a retailer to make a purchase, the client-device may not need to contact a server to determine and identify coupons eligible to the consumer. The client-device may instead consult its own storage for information regarding coupons and discounts applicable to a consumer purchase. In another embodiment, the client-device may also send a verification to the server that particular coupons were redeemed or used. Using such a communication, the server may update a consumer's coupon savings account (CSA) accordingly, by deducting a used coupon from the CSA and/or from the available coupons in the distribution campaign as a whole.

In an illustrative embodiment, any of the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A system comprising:
a memory; and
a processor coupled to the memory, wherein the processor is configured to:
generate a coupon savings account for a consumer, wherein the coupon savings account includes coupon preference data received from a consumer device of the consumer, and wherein the coupon preference data indicates a preference of the consumer for a particular type of product or service;
associate a consumer identifier with the coupon savings account;
receive digital coupon data from an issuer-device, wherein the digital coupon data comprises a discount for the product or service;
associate the digital coupon data with the coupon savings account based at least in part on the coupon preference data;
receive purchase data from a retailer device, wherein the purchase data includes the consumer identifier and an indication that the consumer is purchasing the product or service;
cause the digital coupon data to be sent to the retailer device;
receive purchase confirmation data from the retailer device, wherein the purchase confirmation data indicates that the discount for the product or service was applied;
generate an invoice, wherein the invoice indicates an amount of funds to be transferred from an issuer financial account, and wherein the amount of funds is based on the amount of the discount for the product or service; and
cause the invoice to be sent to the issuer device.

2. The system of claim 1, wherein the consumer identifier is a phone number of the consumer device.

3. The system of claim 1, wherein the processor is further configured to receive demographic data from the consumer device, wherein the demographic data comprises characteristics of the consumer.

4. The system of claim 3, wherein the digital coupon data is associated with the coupon savings account based at least in part on the demographic data.

5. The system of claim 3, wherein the processor is further configured to receive a query from the issuer-device, wherein the query comprises a request for the digital coupon data to be associated with the coupon savings account based on the demographic data.

6. The system of claim 1, wherein the processor is further configured to cause the invoice to be sent to a retailer server.

7. The system of claim 1, wherein the processor is further configured to:
initiate a first debit of funds from the issuer financial account for a first amount based on the discount for the product or service, wherein the first debit of funds is directed to be deposited in a server financial account; and
initiate a second debit of funds from the server financial account for a second amount based on the first debit of funds, wherein the second debit of funds is directed to be deposited in a retailer financial account.

8. A method comprising:
generating, by a processor of a computing device, a coupon savings account for a consumer, wherein the coupon savings account includes coupon preference data received from a consumer device of the consumer, and wherein the coupon preference data indicates a preference of the consumer for a particular type of product or service;
associating, by the processor of the computing device, a consumer identifier with the coupon savings account;
receiving, by the processor of the computing device, digital coupon data from an issuer-device, wherein the digital coupon data comprises a discount for the product or service;
associating, by the processor of the computing device, the digital coupon data with the coupon savings account based at least in part on the coupon preference data;
receiving, by the processor of the computing device, purchase data from a retailer device, wherein the purchase data includes the consumer identifier and an indication that the consumer is purchasing the product or service;
causing, by the processor of the computing device, the digital coupon data to be sent to the retailer device;
receiving, by the processor of the computing device, purchase confirmation data from the retailer device, wherein the purchase confirmation data indicates that the discount for the product or service was applied; and
generating, by the processor of the computing device, an invoice, wherein the invoice indicates an amount of funds to be transferred from an issuer financial account, and wherein the amount of funds is based on the amount of the discount for the product or service; and
causing, by the processor of the computing device, the invoice to be sent to the issuer device.

9. The method of claim 8, wherein the digital coupon data comprises at least two discounts for at least two products or services.

10. The method of claim 9, wherein the amount of funds is based on the amount of the at least two discounts for the at least two products or services.

11. The method of claim 8, further comprising storing, by the processor of the computing device, the purchase data and the purchase confirmation data as a purchase history.

12. The method of claim 11, further comprising associating, by the processor of the computing device, the purchase history with the coupon savings account.

13. The method of claim 12, further comprising receiving, by the processor of the computing device, a query from the issuer-device, wherein the query comprises a request for the digital coupon data to be associated with the coupon savings account based on the purchase history.

14. The method of claim 12, further comprising receiving, by the processor of the computing device, a query from the issuer-device, wherein the query comprises a request for the digital coupon data to be associated with the coupon savings account based on the absence of the purchase data or the purchase confirmation data in the purchase history.

15. A non-transitory computer readable medium having instructions stored thereon for execution by a processor, the instructions comprising:
instructions to generate, by the processor, a coupon savings account for a consumer, wherein the coupon savings account includes coupon preference data received from a consumer device of the consumer, and wherein the coupon preference data indicates a preference of the consumer for a particular type of product or service;
instructions to associate, by the processor, a consumer identifier with the coupon savings account;
instructions to receive, by the processor, a digital coupon data from an issuer-device, wherein the digital coupon data comprises a discount for the product or service;
instructions to associate, by the processor, the digital coupon data with the coupon savings account based at least in part on the coupon preference data;
instructions to receive, by the processor, purchase data from a retailer device, wherein the purchase data includes the consumer identifier and an indication that the consumer is purchasing the product or service;
instructions to cause, by the processor, the digital coupon data to be sent to the retailer device;
instructions to receive, by the processor, purchase confirmation data from the retailer device, wherein the purchase confirmation data indicates that the discount for the product or service was applied; and
instructions to generate, by the processor, an invoice, wherein the invoice indicates an amount of funds to be transferred from an issuer financial account, and wherein the amount of funds is based on the amount of the discount for the product or service; and
instructions to cause, by the processor, the invoice to be sent to the issuer device.

16. The non-transitory computer readable medium of claim 15, further comprising instructions to set, by the processor, a limit for a total number of times the processor may cause the digital coupon data to be sent to the retailer device.

17. The non-transitory computer readable medium of claim 16, further comprising instructions to track, by the processor, a to-date number of times the processor has sent the digital coupon data to the retailer device, such that if the limit for the total number of times is met, the processor will not cause the digital coupon data to be sent to the retailer device.

18. The non-transitory computer readable medium of claim 15, further comprising instructions to set, by the processor, a limit for a total number of times the processor may send the digital coupon data to the retailer device in connection with the coupon savings account.

19. The non-transitory computer readable medium of claim 18, further comprising instructions to track, by the processor, a to-date number of times the processor has sent the digital coupon data to the retailer device in connection with the coupon savings account, such that if the limit for the total number of times is met, the processor will not cause the digital coupon data to be sent to the retailer device.

20. The non-transitory computer readable medium of claim 15, further comprising instructions to receive, by the processor, the digital coupon data from the retailer device.
